(19) United States
(12) Patent Application Publication
(10) Pub. No.: US 2002/0189541 A1
(43) Pub. Date: Dec. 19, 2002

(54) Glue dropping machine

(76) Inventor: Lily Chao, Taipei (TW)

Correspondence Address: BACON & THOMAS, PLLC, 625 SLATERS LANE, FOURTH FLOOR, ALEXANDRIA, VA, 22314

(21) Appl. No.: 09/880,060

(22) Filed: Jun. 14, 2001

(51) Int. Cl. B05C 11/00

(52) U.S. Cl. 118/684; 118/679; 118/682

(57) ABSTRACT

The present invention relates to a glue dropping machine mainly comprising an air-compressing source, a main air-compressing circuit designed with a pressure-adjusting valve, a pressure meter and a tri-valve; said main air-compressing circuit is connected to a soft tube at the other end, a secondary air-compressing circuit designed with a pressure-adjusting valve and a diverging tube perpendicular to the secondary air-compressing circuit. The diverging tube is connected to the top of the tri-valve at the other end and the secondary air-compressing circuit is opened to the air such that the diverging tube produces a negative pressure; a gun pistol using the power of the pressure to allow flow of glue through the needle head. A timing controller to control the tri-valve at the left-right valve and at the right valve.

The negative pressure of the diverging tube causes the absorption of the glue flowing out. This procedure depends on the setting of the controller and is not determined by the pressuring button for fixed perfect timing.

### TECHNICAL RANGE

The present invention relates to a glue applying machine mainly one dropping fixed amount of glue without leaving any residue.

### INVENTION BACKGROUND

The main function of the glue applying machine is to drop fixed amount of glue and can be used in semi-finished products, manual art crafts, computer appliances such as motherboards, keyboards, mice, indicators, printers, and so on.

According to generally used glue applicators, glue is being pushed out by pressure and uses spiral force to apply glue. The main drawback of the above-mentioned is that there is residue left at the needle head. As most glue applying procedure is done in an interrupted way, glue still continue to flow even after stopping of power such that some residue is left at the needle head and unstable amount of glue is being dropped out. This is very inconvenient for the user and affects work efficiency as well as quality of products.

In order to obviate the above drawback, the present invention emphasizes on the stability of the machine such that there is no unwanted residue.

The main object of the invention is to drop fixed amount of glue using a secondary pressing tube to produce a negative pressure and absorption such that there is no residue left after each procedure. The stability of amount of glue being dropped is determined by a timing controller instead of a pressing button which controls accurate length of time.

For further understanding of the invention, please refer to the drawings and descriptions below:

### DESCRIPTION OF DRAWINGS

FIG. 1 shows a structure of the present invention.

FIG. 2 shows a three-dimensional view of the gun.

FIG. 3 shows a view of glue dropping procedure.

### NUMERICALS

1—air-compressor mover

2—main air-compressing

3—secondary air-compressing circuit

4—timing controller

5—gun

6—soft tube

7—power button

11—air-providing tube

22—pressure-adjusting valve

23—pressure meter

24—tri-valve

31—air-adjusting valve

32—diverging tube

41—operating plate

51—rear cover

52—tubular body

53—needle head

54—pressing button

55—wire

521—pistol

522—glue

221—manual adjusting button

### BEST MODE FOR CARRYING OUT INVENTION

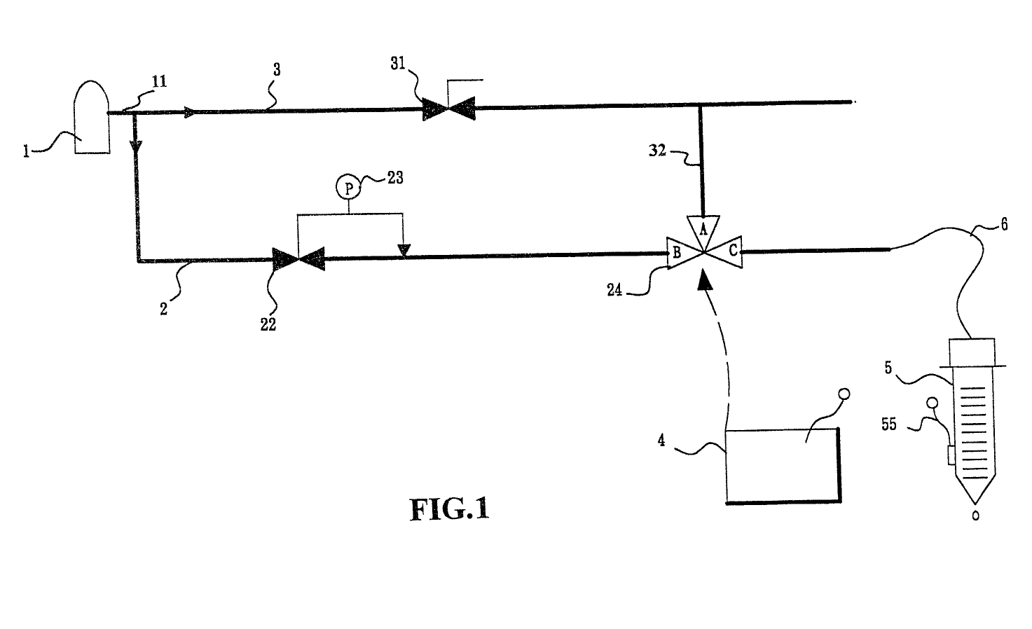

With reference to FIG. 1 showing a structure of the present invention, the invention mainly consists of an air-compressing source 1, a main air-compressing circuit 2, a secondary air-compressing circuit 3, a timing controller 4 and a glue gun 5. Said main air-compressing circuit 2 and secondary air-compressing circuit 3 are connected at one side to air-compressing source 1. In fact, as shown in the drawing, air-compressing source 1 and air-compressing circuit 2 are each connected at one side to an air-providing tube 11 coming from the air-compressing source 1. A pressure-adjusting valve 22, a pressure meter 23 and a tri-valve 24 are designed along the main air-compressing circuit 2 connected at one side to a soft tube 6 which, in turn, is connected at the other side to rear cover 51 of glue gun 5. Further, an air-adjusting valve 31 and a diverging tube 32 perpendicular to the secondary air-compressing circuit 3 are designed along said secondary air-compressing circuit 3. Said diverging tube 32 is connected to the top end A of tri-valve 24 and the secondary air-compressing circuit 3 is opened to the air such that the diverging tube 32 should be as short as possible for more negative pressure.

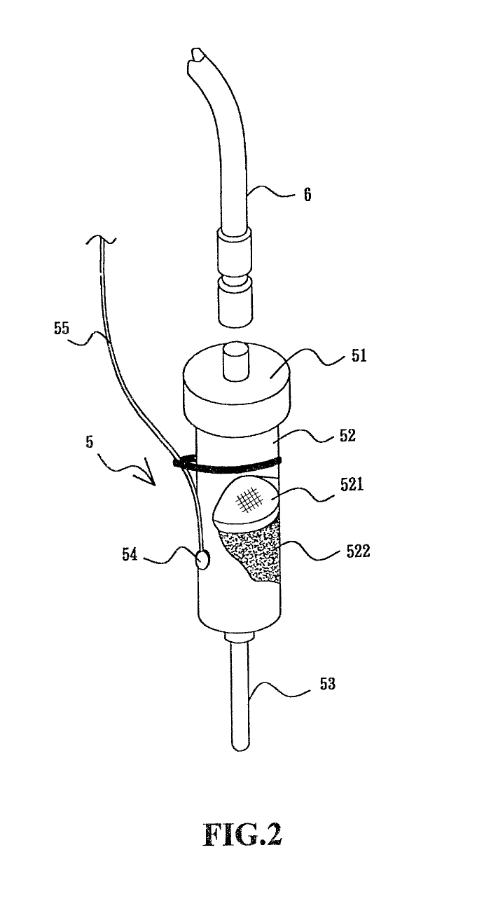

With reference to FIG. 2 showing a three-dimensional view of the gun, said gun consists of a rear cover 51, a tubular body 52 and a needle head 53. The tubular body 52 is designed with a pistol 521 and glue 522 can be filled inside the space below said pistol 521 such that glue 522 is being pushed through the needle head 53 due to pressure activating the pistol 521. Any similar or more complicated pistol gun can be used. A pressing button 54 is designed at the outer wall of tubular body 52 and linked to the timing controller 4 by means of a wire 55.

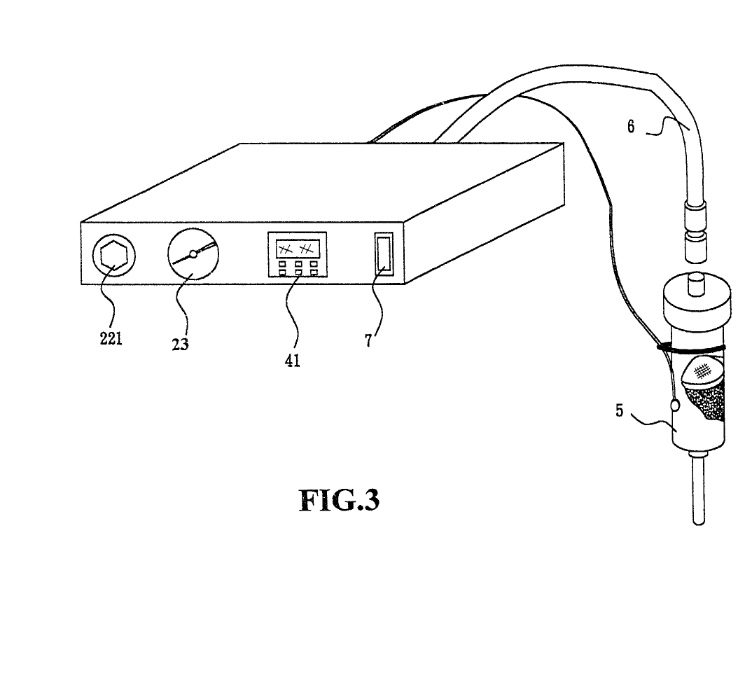

With reference to FIG. 3 showing a view of glue dropping procedure, manual adjusting button 221 of pressure-adjusting valve 22, pressure meter 23, operating plate 41 of timing controller 4 and power button 7 are displayed at the front of plate and air exit hole (not shown in drawing, found at the rear end of secondary air-compressing circuit) as well as air entry hole (not shown in drawing, found at entry section of air-providing tube) are found at the back of plate.

The timing controller 4 described above controls the passage of the tri-valve 24 mainly passage B-C (left-right) or A-C (up-right) and time of passage B-C. when in use, timing controller 4 is primarily set, for example 0.01 second and with the help of pressure adjusting valve 22, pressure of main air-compressing circuit 2 is adjusted to a suitable level indicated by the pressure meter. Then, if pressing button 54 of gun 5 is pressed, the timing controller will cause successive passages of 0.01 second from section B-C of the tri-valve 24 and glue 522 is dropped out from needle head 53 of gun 5 within each 0.01 second. After each 0.01 second, the timing controller 4 will cause successive passages from section A-C of the tri-valve 24 and passages from section B-C will be closed. Further, as section A of passages from section B-C will be closed. Further, as section A of the tri-valve 24 is connected to the diverging tube 32 of secondary air-compressing circuit 3, the negative pressure of said diverging tube 32 will cause the gun 5 to absorb glue 522 such that there is no residue left. In order to comply with different glue qualities and functions, an air-adjusting valve 31 is also designed in the secondary air-compressing circuit to adjust negative pressure and absorption of diverging tube 32 of the secondary air-compressing circuit 3.

We can thus understand that the dropping of glue is controlled by the number of times pressing button of gun 5 is being pressed and flowing time of glue is controlled by the timing controller 4. Further, the negative pressure of the diverging tube 32 eliminates the problem of residue. Hence, this kind of procedure not only eliminates the problem of residue, but also emphasizes on the stability of glue being dropped out, thus increasing work efficiency as well as quality of product.

Although the above specification and examples of the present invention have been described for purposes of illustration, they should not, however, be taken as a limitation on the scope of the present invention, but rather the invention should only be interpreted in accordance with the claims below.

1. A glue dropping machine comprising:
an air compressing source;
a main air-compressing circuit connected to an air-compressing source at the upper side and designed with an adjusting valve, pressure meter and a tri-valve and connected to a soft tube at the other side;
a secondary air-compressing circuit connected to the air-compressing source at the upper side and designed with an air-adjusting valve and a diverging tube perpendicular to the secondary air-compressing circuit. The diverging is connected at the other side to the top end of the tri-valve and the secondary air-compressing circuit is opened to the air such that the diverging tube produce a negative pressure;
a gun, mostly a pistol gun, comprising a rear cover, a tubular body and a needle head. The rear cover is connected to the other side of the soft tube described above and glue is filled into the pistol and pushed through the needle head due to pressure activating the pistol. A pressing button is designed at the outer wall of the tubular body and linked to the timing controller by means of a wire; and
a timing controller controlling passages of the tri-valve, mainly passage from left-right or up-right and time of passage from left-right. When in use, timing controller primarily sets length time of passage and with the help of the pressing adjusting tube, pressure of main air-compressing circuit is adjusted to a suitable level and when pressing button of gun is pressed, the timing controller will cause successive passages within set time from left-right of the tri-valve. The gun is activated within set time and glue is pushed out through the needle head. The timing controller causes successive passages from up-right and passages from left-right will be closed. The tri-valve is connected at the top end to the diverging tube of the secondary air-compressing circuit and a negative pressure of said diverging tube will cause the gun to absorb glue such that there is no residue left and dropping of glue is more stable.

2. As described in claim 1 of a glue dropping machine, the air adjusting valve of the secondary air-compressing circuit adjusts negative pressure and absorption of diverging tube in order to comply with different glue qualities and functions.
